(19) United States
(12) Patent Application Publication
(10) Pub. No.: US 2026/0221325 A1
(43) Pub. Date: Jul. 30, 2026

(54) LOW VOLTAGE INSULATION FOR HIGH-TEMPERATURE SUPERCONDUCTING MAGNETS

(71) Applicants: Massachusetts Institute of Technology, Cambridge, MA (US); Commonwealth Fusion Systems LLC, Devens, MA (US)

(72) Inventors: Alexey RADOVINSKY, Cambridge, MA (US); Sergey KUZNETSOV, Attleboro, MA (US); Nicholas J. KELTON, Somerville, MA (US); Brian LABOMBARD, Belmont, MA (US); Christopher CRAIGHILL, Groton, MA (US); Christopher J. LAMMI, Lynnfield, MA (US); Charlie SANABRIA, Shirley, MA (US)

(73) Assignees: Massachusetts Institute of Technology, Cambridge, MA (US); Commonwealth Fusion System LLC, Devens, MA (US)

(21) Appl. No.: 19/131,082

(22) PCT Filed: Nov. 28, 2023
(86) PCT No.: PCT/US2023/081302

§ 371 Date: May 19, 2025

Related U.S. Application Data
(60) Provisional application No. 63/385,249, filed on Nov. 29, 2022.

(51) Int. Cl. H01F 6/06

(52) U.S. Cl. CPC H01F 6/06

(57) ABSTRACT

Described is an insulative layer for use in systems utilizing a high temperature superconductor (HTS). The insulative layer comprises a first layer of an insulative material, a second layer of an insulative material and a third layer of an electrically conductive material disposed the first and second layers. The electrically insulating material of the first layer and the electrically insulating material of the second layer are both resistant to grinding forces. The third layer is provided from a material having a resistance to oxidative degradation, weather, and radiation, as well as resistance to abrasive and fictional wear at cryogenic temperatures. In one application, the insulative layer may be disposed at an interface between a toroidal field (TF) coil and a central solenoid (CS) of a high temperature superconducting magnet.

### FIELD

This application relates to high-temperature superconducting magnets.

### BRIEF DESCRIPTION OF THE DRAWINGS

The foregoing features may be more fully understood from the following description of the drawings. The drawings aid in explaining and understanding the disclosed technology. Since it is often impractical or impossible to illustrate and describe every possible embodiment, the provided figures depict one or more exemplary embodiments. Accordingly, the figures are not intended to limit the scope of the invention. Like numbers in the figures denote like elements.

FIG. 1A is an isometric view of a tokamak fusion reactor design.

FIG. 1B is a cross sectional view of conductive structures (e.g., a stack of pancakes of a high temperature superconducting magnet).

FIG. 2A is a cross sectional view of toroidal field (TF) coils and a central solenoid (CS).

FIG. 2B is an enlarged portion of the TF coils and CS of FIG. 2A.

FIG. 3 is a cross sectional view of an insulating layer.

FIG. 4 is a cross sectional view of two structures with insulating layers placed between the structures.

FIG. 5 is a cross sectional view of two structures with insulating layers placed between the structures.

FIG. 6 is a top view of a CS wrapped in an insulating layer.

FIG. 7 is a top view of a CS wrapped in an insulating layer.

FIG. 8 is a top view of a CS wrapped in an insulating layer.

FIG. 9 is a cross sectional view of two structures, a fastener holding the two structures, and insulating layers between the structures and a fastener.

FIG. 10 is a cross sectional view of sections of insulating layers.

FIG. 11A is a cross sectional view of an insulating stack having staggered plates and staggered insulating layers; and

FIG. 11B is a cross sectional view of another embodiment of an insulating stack having staggered plates.

### DETAILED DESCRIPTION

The concepts, systems, structures and techniques described herein address issues in systems which utilize a high-temperature superconducting (HTS) material. In particular, the concepts, systems, structures and techniques described herein relate to low-voltage insulation between structural elements which may be included in HTS systems (i.e., insulating electrically conducting structure 1 from structure 2).

As one example, the described concepts, systems, structures and techniques may find use in HTS magnets. Such insulation may be positioned over flat or curved interfaces between electrically conducting structural elements, constantly or incrementally subjected to different electrical potentials (e.g., potentials less than or equal to about 10V). It should be appreciated that for reasons of clarity, reference is sometimes made herein to use of the insulative structures and techniques described herein with fusion reactors, HTS magnets (including, but not limited to HTS magnets included in fusion reactors).

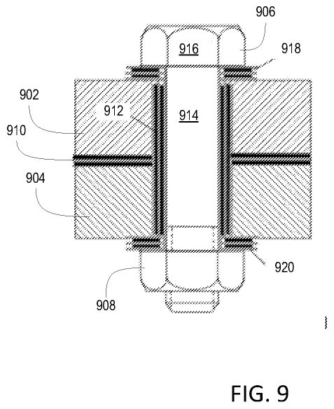

Reference is also sometimes made herein to particular types of HTS magnets. Such references are not intended to be, and should not be, construed as limiting. It is recognized the concepts, systems, structures and techniques described herein generally relate to insulating a one electrically conducting structure from a second structure. In embodiments, insulated structures may be used, for example: (a) between so-called “pancakes” in an HTS magnet (e.g., between pancakes in a toroidal field (TF) magnet included in a fusion reactor); (b) as ground insulation between pancakes and a structural case of an HTS magnet (e.g., a TF magnet); (c) as insulation between structural TF elements; (d) as insulation between structural TF elements and a central solenoid (CS) (e.g. an outside diameter (OD) of a CS); (e) to insulate any other electrically conducting parts, bolted or otherwise coupled together (e.g., as shown in FIG. 9).

In the case or HTS magnets, in some cases, surfaces of structural elements of HTS magnets may geometrically align with each other over large contact surfaces. The magnetic fields produced by the HTS magnets (and the resulting Lorenz forces) may cause the structural elements on both surfaces of the contacting interface to move, which can damage the structure of the HTS magnets. For example, the Lorenz forces may cause structural elements of HTS magnets to grind and wear.

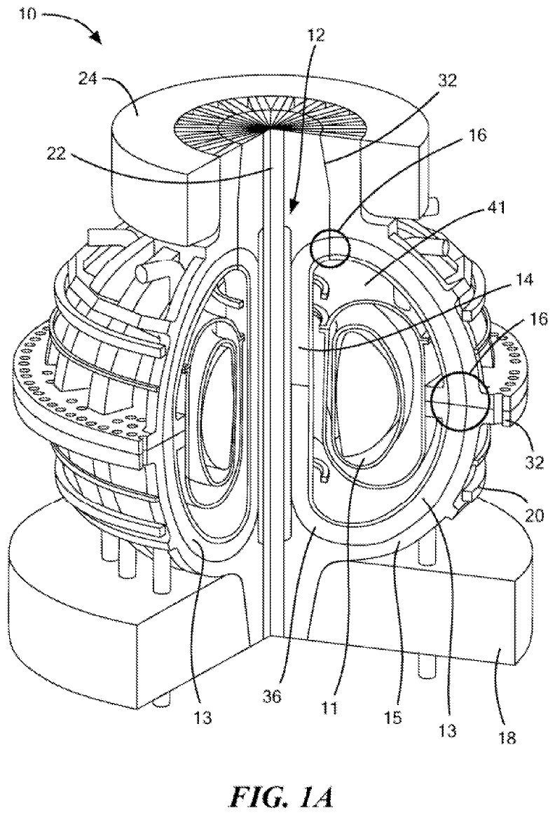

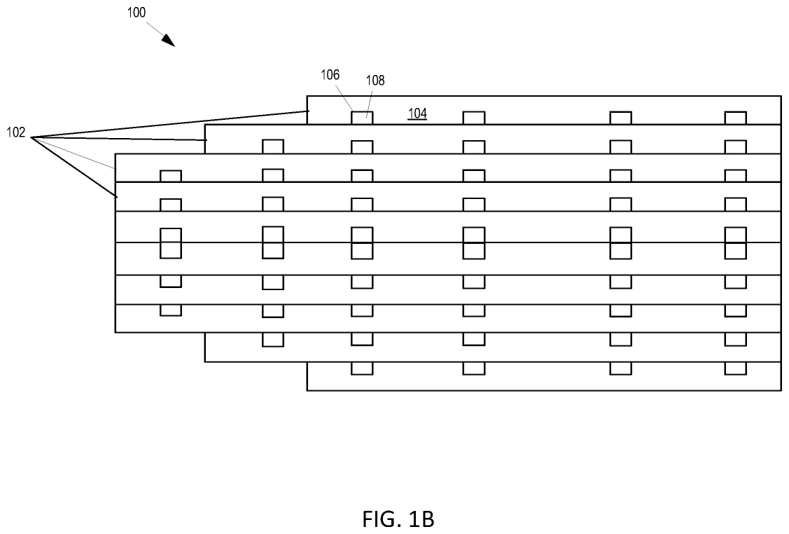

FIG. 1A is a perspective view of a fusion reactor 10 comprising a vacuum vessel 11. The vacuum vessel 11 is disposed in a radiation shield (or “shield tank”) 41.

Vacuum vessel 11 and radiation shield are disposed about a central solenoid 12. Toroidal field (TF) magnets 13 are disposed about vacuum vessel 11. In this example embodiment, the TF magnets are provided as HTS magnets 13 having a D-shape. Other magnet shapes may, of course, also be used.

The body of the HTS magnets may be formed from a conductive metal, often in the form of a baseplate having one or more superconducting current paths formed from stacks of HTS tape provided therein. The combination of the baseplate and the HTS tape may be referred to herein as an “HTS Coil,” an “HTS Magnet,” or simply a “coil.”

In embodiments, the HTS tape may wind around the body of the baseplate one or more times forming a looped winding through the HTS magnet. This allows current to flow through the HTS coil to generate a high-strength magnetic field. The conducting channel through the baseplate may also have (in addition to the HTS tape) a conductive material (sometimes referred to as a “co-wind”) disposed therein. In embodiments, a conductor may be disposed over the HTS as a cap. According to some embodiments, the HTS may comprise a rare earth barium copper oxide superconductor (REBCO), such as yttrium barium copper oxide (YBCO). In some embodiments, the HTS may comprise a co-wound stack of HTS tape.

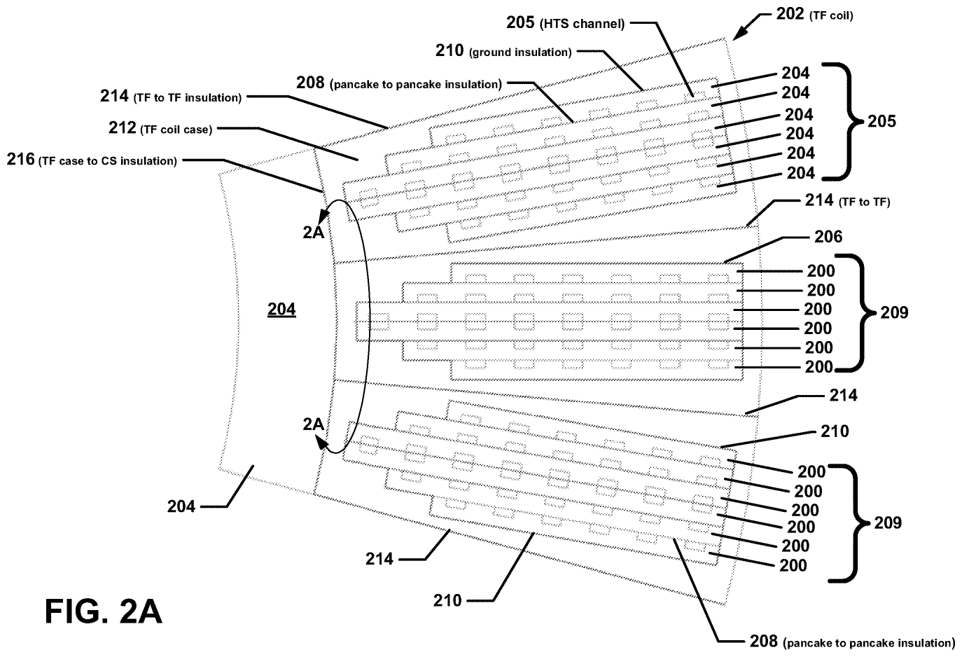

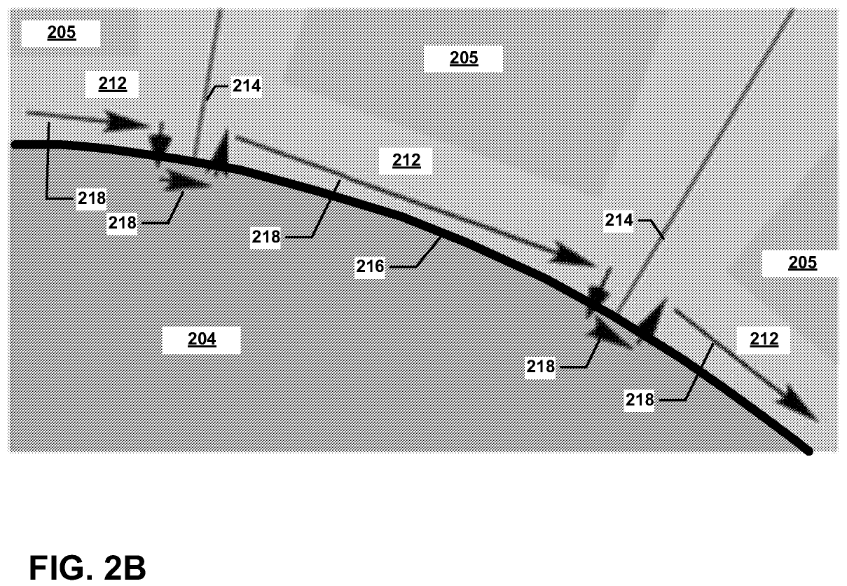

In embodiments, the HTS magnets 13 may comprise a plurality of HTS coils arranged in a stack or wedge (with a wedge shape being shown, for example in FIGS. 1B and 2A). In this arrangement, the HTS coil may be referred to as a “pancake” and the stacked plurality of HTS coils may be referred to as a “stack of pancakes” (and sometimes referred to as a “wedge of pancakes” when arranged in a wedge configuration as shown in FIGS. 1B and 2A). These HTS pancakes may be used, for example, to form the toroidal field magnets 13 shown in FIG. 1B.

Referring to FIG. 1B, a cross sectional view of a wedge of HTS pancakes is shown. Each pancake 102 may include a baseplate 104, which is typically formed from a conductive material such as steel. The baseplate 104 may have a groove 106 (or series of grooves) through which HTS material 108 (e.g., HTS tape) is wound. In other embodiments, channels 106 may correspond to cooling channels and HTS may be deposited in other grooves, not illustrated in FIG. 1B). The HTS material 108 may form a superconductive path that can carry current to form a magnetic field. In embodiments, the HTS material 108 comprises a stack of HTS tapes. In embodiments, the pancakes may form a toroidal shape (as shown in FIG. 1A), and thus may be referred to a toroidal field (TF) coils.

Referring now to FIGS. 2A and 2B in which like elements are provided having like reference designations, a plurality of TF coils 202 are disposed about a central solenoid (CS) 204 which may be the same as or similar to the central solenoid 12 described above in conjunction with FIG. 1A. TF coils 202 comprise a plurality of TF pancakes 204 arranged in a wedge shape and when taken together form a coil pack denoted with reference numeral 205 in FIGS. 2A and 2B. Pancakes 204 have one or more channels 205 in which HTS material is disposed (e.g., may be disposed in HTS channels 205). Insulation 208 (so-called pancake-to-pancake insulation) is disposed between the TF pancakes 204. Ground insulation 210 is disposed about the TF pancakes 204 encasing them in a TF structural case 212 (also sometimes referred to as a “TF coil case” or more simply a “coil case”).

Insulation 214 (so called TF-to-TF insulation) is disposed between each TF coil case 212.

Insulation 216 (so called TF-to-CS insulation) is disposed at the interface of the CS and the TF coil case (i.e., between the outer diameter (OD) of the CS 204 and the inner diameter (ID) of the TF coil case 212).

As noted, the TF pancakes 200 have pancake to pancake insulation 206 disposed thereabout and ground insulation 210 is disposed between the TF coil and he TF coil case 203. Without pancake to pancake insulation 206 during charging of TF coils transport current will bypass the HTS winding through the electrically conducting structure and charging will take much longer. Also, during the plasma shot generated by varying in time magnetic field eddies which may bring HTS magnets to high temperatures (and, in the worst-case scenario to temperatures exceeding superconducting limits or at least imposing huge thermal load on cryogenics).

FIG. 2B shows the path of eddy currents in case of uninsulated CS-TF interface and insulated TF-TF interface.

Referring now to FIG. 2B. shown is an interface between an OD of a CS and an ID of a TF coil case as may be present in a fusion reactor design. If TF coils are bucked against the OD of the CS (i.e., without an insulating layer therebetween), then eddy currents can result. The path of such eddy currents in case of an uninsulated CS-TF interface and insulated TF-TF interface is illustrated by reference numerals 218.

At this interface, Lorentz forces due to the constant TF currents and variable CS currents during the plasma shot are always compressive (e.g., up to 300 MPa of normal pressure). Interaction between the variable in time fields of the CS with the currents of the TF coils create so-called Out-of-Plane (OOP) forces, tending to deform the TF inner legs, those in contact with the CS, in the circumferential direction, tangentially to the cylindrical interface between the TF and the CS OD surface. Also, during the shot the variation of the axial flux, created by the CS and poloidal field (PF) coil currents and the plasma, induces eddy-currents in the steel structure of the TF coil cases. Even if the TF coil cases are perfectly insulated from one another, without electrical insulation at the TF-CS interface 205 such eddies may form a closed circular path (shown by arrows 218) through the cases 203 of the TF coils, bridged through the electrically conducting structure around the OD of the CS as illustrated in FIG. 2B. Resistive losses associated with these eddy currents add to the heat loads on the cryogenic system and preferably are reduced (and ideally reduced to a minimum possible value). This can be accomplished either by reducing the thickness of the CS OD inter-TF coil electrically conducting bridges.

Alternatively, and as illustrated in FIG. 2B, eddy currents can be reduced or substantially eliminated (and ideally, completely eliminated) by introducing insulation 216 between the CS OD and the TF coil case ID. Once again, this electrical insulation shall be resistant to the “grinding” mechanical interaction between the TF inner legs and the CS OD.

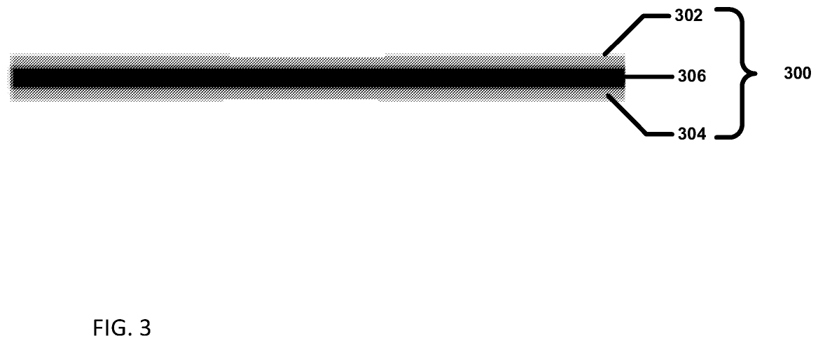

Referring to FIG. 3, shown is an insulative layer 300 that may be disposed at any desirable location including but not limited to between: (a) pancakes in a TF magnet between themselves (e.g., pancake-to-pancake insulation 208 in FIG. 2A); (b) ground insulation between pancakes and a structural case of a TF magnet (e.g., insulation 210 in FIGS. 2A and 2B); (c) insulation between structural TF cases (e.g., insulation 214 in FIGS. 2A and 2B); (d) insulation between structural TF cases and an OD of a central solenoid (CS) (e.g., insulation 216 in FIGS. 2A and 2B); and/or (e) any other electrically conducting parts, bolted or otherwise secured together with an insulative layer (or more simply, “an insulator” or “insulation”) between some or all of the conducting parts (e.g., as shown in FIG. 9). Thus, any of insulative layers 206, 208, 210, 214, 216 may be provided having the structure of insulative layer 300. In the example embodiment of FIG. 3, the insulative layer 300 comprises three layers: a top layer 302 and a bottom layer 304 formed from a wear-resistant insulating material, and a middle layer 306 formed from a conductive material such as sheet metal (e.g., steel), for example. In embodiments layer 306 may be provided from shim stock sheet-metal having a thickness of about 0.25 mm with a wear-resistant insulating material 302, 304 deposited on opposing surfaces thereof. In embodiments, one or all of layers 302, 304, 306 may themselves comprise multiple layers. The plates used to form the shim stock sheet-metal 306 layer may be referred to as “sheet metal plates” in this document. However, the plates may be formed from other material (e.g., any electrically conductive material) and are not limited to sheet metal.

In embodiments, the insulating material may have resistance to oxidative degradation, weather, and radiation, as well as resistance to abrasive and fictional wear at cryogenic temperatures. For example, the insulative layer may be formed from or comprise an insulative material such as a polymer, for example, a polyimide, such as a 650-or 650-T series polyimide by JARO CORP. In embodiments, metal layer 306 may have a thickness ranging between about 25 microns to about 0.25 mm. The metal layers may also be relatively elastic, which may allow them the withstand grinding or compressive forces from the magnet. The insulating material layers 302, 304 may have a thickness ranging between about 25 microns mm to about 2.0 mm, in some cases.

In embodiments, the insulative layer 300 may be formed into a plate, which may be disposed at any desirable location. Such locations include but are not limited to:
insulation between pancakes in a TF magnet (e.g., pancake-to-pancake insulation 208 in FIG. 2A); ground insulation between pancakes and a structural case of a TF magnet (e.g., ground insulation 210 in FIG. 2); TF-to-TF insulation between structural TF cases (e.g., insulation 214 in FIG. 2A); insulation between structural TF cases and an OD of a CS (e.g., insulation 216 in FIG. 2A); and/or insulation between any other electrically conducting parts, bolted or otherwise secured together ..

Insulative layer 300 may be provided having any surface shape (e.g., any flat or contoured surface shape). In embodiments, is may be desirable to provide an insulative layer (such as insulative layer 300) which conforms to the shape of the structures between which the insulative layer is disposed. In embodiments, an insulative layer (such as insulative layer 300) may be placed between some or all regions/surfaces of TF-CS interfaces depending upon design requirements.

In embodiments, an insulative layer (e.g., a pancake-to-pancake insulator such as insulator 208 in FIG. 2A) may be disposed on or between some or all regions/surfaces between pancakes included in an HTS magnet. In embodiments, an insulative layer (e.g., ground insulation 210 in FIG. 2A) may be disposed on or between some or all regions/surfaces of an interface between pancakes and a structural case of a TF magnet. In embodiments, an insulative layer (e.g., insulation 214 in FIG. 2A) may be disposed on or between some or all regions/surfaces of structural TF cases. In embodiments, an insulative layer (e.g., insulation 216 in FIGS. 2A and 2B) may be disposed on or between some or all regions/surfaces or one or more structural TF coil cases and an OD of a central solenoid (CS). In embodiments, an insulative layer may be disposed on or between some or all or regions/surfaces of any electrically conducting parts which are bolted or otherwise secured together.

As noted above in conjunction with FIG. 2B, when disposed at an interface of a TF coil case and a CS, insulation layer 300 may reduce the flow of eddy currents between the TF and CS described above. Accordingly, damaging Lorenz forces that can be caused by these eddy currents may also be reduced or eliminated. In embodiments, multiple insulative layers may be stacked together, and these multiple layers may be placed at the interface between TF coils and/or the CS.

The insulative layers are disposed to reduce (and ideally prevent) the eddy currents described above from forming, which may reduce (and ideally prevent) the damaging Lorenz forces from crushing or grinding the coils. However, even in the presence of the damaging Lorenz forces, the insulative layer may provide physical protection of structures (such as TF coils, CS or other structures included in a magnet, for example) from damage.

As noted above, magnetic fields produced by a magnet, especially during magnet start up, shut down, or quench, may produce crushing or grinding Lorenz forces between TF pancakes and/or between TF pancakes and a TF structural case and/or between a TF structural case and a CS and/or between structural TF cases and/or any other electrically conducting parts, bolted or otherwise secured together with insulator between some or all of the conducting parts.

In embodiments, if these forces remain high even in the presence of the insulative layers between the pancakes and/or between TF pancakes and a TF structural case and/or between a TF structural case and a CS and/or between structural TF cases and/or any other electrically conducting parts, bolted or otherwise secured together with insulator between some or all of the conducting parts, the insulative layers may act to withstand and/or absorb those forces so that the aforementioned structures (e.g., pancakes, TF structural cases, CS) do not become damaged.

In some instances, the insulative layer may become damaged by the Lorenz forces. In these cases, the insulative layer 300 may be replaced.

As shown, in FIGS. 4 and 5 there are double insulating layers between sheets and there may be a gap between insulating layers. It should, of course, be appreciated that in some embodiments it may be desirable or necessary to utilize other configurations. For example, in some embodiments, an option with a stack comprised of alternating layers of a metal sheet and an insulator may be used (e.g., one metal sheet, one layer of insulator, another metal sheet another layer of insulator, etc.). Such embodiments may comprise one or more metal sheet layers and one or more insulator layers.

Referring to FIG. 4 and FIG. 5, multiple insulative layers (e.g., insulative layers 300a, 300b in FIG. 4) may be disposed between two structures (e.g., structures 406, 408 in FIG. 4), at least one of which is electrically conductive.

For example, in FIG. 4, a pair of insulative layers 300a, 300b are disposed between electrically conductive structures 406 and 408. Like insulative layer 300 (FIG. 3), each insulative layer 300a, 300b comprises first and second layers of insulating material 302a, 304a, 302b, 304b disposed about respective ones of conductive materials 306a, 306b (e.g., layers of sheet metal). Thus, when insulative layers 300a, 300b are disposed adjacent to each other, the bottom insulating material 304a of insulating layer 300a and the top insulating material 302b of insulating layer 300b are in contact. With this approach, double layers of insulating material (layers 304a, 302b) are disposed between conductive (e.g., metal) sheets 306a, 306b. Thus, if one layer of insulating material (or a portion of one layer of insulating material) breaks or is otherwise compromised, the other layer of insulating material may still be structurally intact.

In FIG. 5, a plurality of insulative layers, here four insulative layers 300a 300d, are disposed between two structures 418 and 420 at least one of which is electrically conductive. Structures 418, 420 in FIGS. 4 and 5 can, for example, be: (a) pancakes in a TF magnet; or (b) a pancake and a structural case of a TF magnet; or (c) a pair of structural TF cases; or (d) a structural TF case and an OD of a central solenoid (CS); or (e) any other electrically conducting parts, coupled or otherwise secured or fastened (e.g., bolted) together (e.g., as shown in FIG. 9) with one or more insulating layers 300a-300d disposed therebetween.

Use of more than one insulative layer between structures (e.g., such as structures 418, 420) may increase the electrical resistance between the structures (e.g. between a TF-CS interface) and may also provide additional physical protection from crushing or grinding forces.

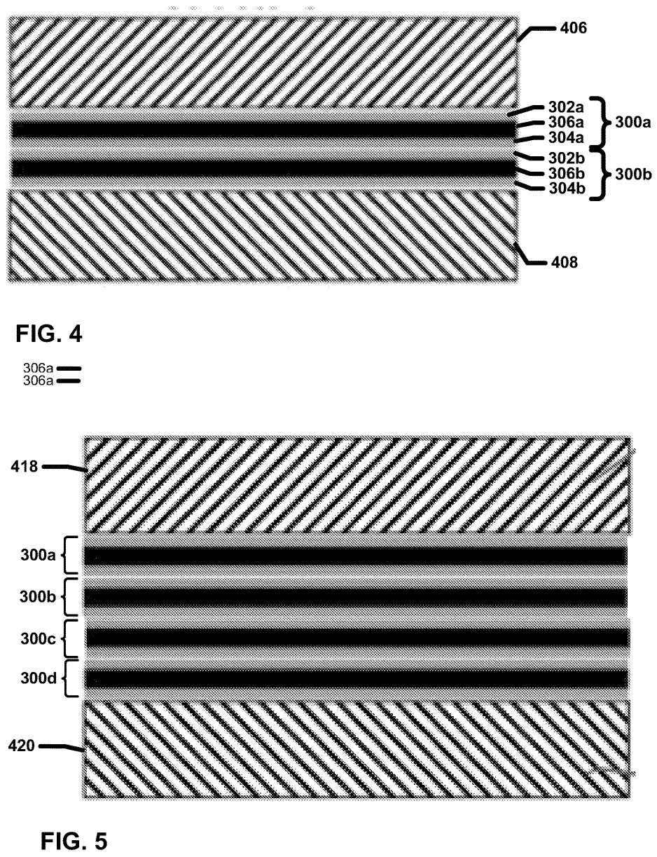

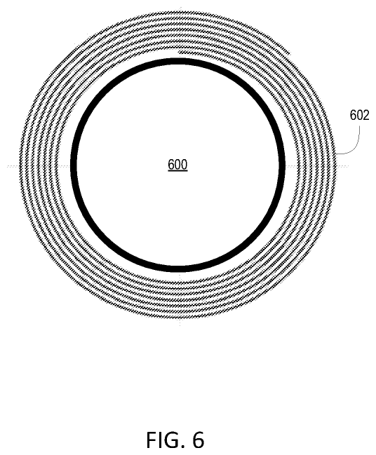

FIG. 6 is top view of a structure 600 (e.g., a TF coil case) surrounded by an insulative layer 602, which may be the same as or similar to any of the insulative layers described herein. In this example, the insulative layer (e.g., layer 602) may be spirally wound around structure 600.

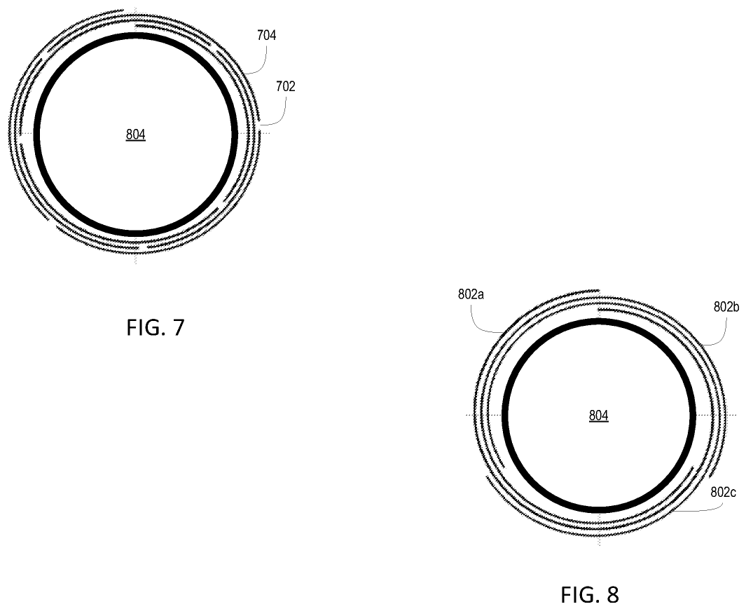

Referring to FIGS. 7 and 8, in some instances, it may be beneficial to break a spiral wound insulative layer so that a high voltage does not build up from end-to-end of the spiral. To alleviate a high voltage buildup, breaks (such as break 702) may be created in the spiral insulative layer 704 so that the spiral forms shorter segments (e.g., segments spaced apart by breaks or openings 702). The short segments provide a lower likelihood that a high voltage will build up from end-to-end of any individual segment.

In FIG. 8, an insulative layer 802 is formed from overlapping segments 802a, 802b, 802c (e.g., each segment may correspond to an insulative layer such as any of the insulative layers described herein). The segments 802a, 802b, 802c may be individually placed and layered around a structure 804. Like the segmented spiral of insulative layer 704, each segment of layer 802 is relatively short so that a high voltage cannot form from end-to-end of the segments. In embodiments, the breaks can be formed with a water-jet cutter, or other type of cutting tool.

FIG. 9 depicts an abovementioned connection of two structural elements 902, 904 (shown with cross-hatched shading in FIG. 9). In this example embodiment, structural elements 902, 904 are secured via a bolt 906 and nut 908 with insulative materiel disposed between at least some surfaces of the structural elements, bolt and nut. Fastening structures and techniques other than a nut and bolt may also be used to secure structural elements and insulation as described herein may also be used with such techniques. The structural elements 902, 904 may, for example, correspond to pancakes of an NI magnet.

The insulation can form washers 918 under the heads of nuts 908 and bolts 906 and a wrap 912 around the bolt. A thin layer of Teflon (or other insulative material) can be placed at the interface between the laminated washer 918 and the head 916 of the bolt 906 or a nut to reduce friction from tightening. The wrap around the cylindrical part of the bolt 914 can be arranged in a spiral (e.g., as shown in FIG. 6) to simplify its application and avoid different sizing for different diameters of the bolt.

Although not shown, a plurality of bolts or fasteners may be used to fasten the structures together.

As described above, an insulative layer 910 may be placed between structural element 902 and structural element 904. Also as described above, eddy currents may form during magnet start up, shut down, or during a quench event. To reduce or prevent eddy currents from flowing through the fasteners (e.g., the bolt 908 and/or the nut 908), insulative layers may be positioned between the bolt 906 and the pancakes 902, 904, and between the nut 908 and the structural elements 902, 904. Thus, providing an insulative layer around the bolt 906 may reduce or eliminate the eddy currents and, consequentially, reduce or eliminate harmful Lorenz forces caused by the eddy currents.

In this example, bolt 906 may be wrapped with a layer of insulative material 912 to provide insulation between the bolt 906 and the structural elements 902, 904. The shaft portion 914 of the bolt that passes through pancakes may be smooth and unthreaded so that the insulative layer 912 can be more easily wrapped around the shaft 914, and so that the interface between the bold and the insulative layer 912 does not include gaps.

To provide insulation between the pancakes and the bolt head 916, and insulative layer 918 may be added between the bold head 916 and the pancakes. Likewise, an insulative layer 920 may be added between the num 908 and the pancakes.

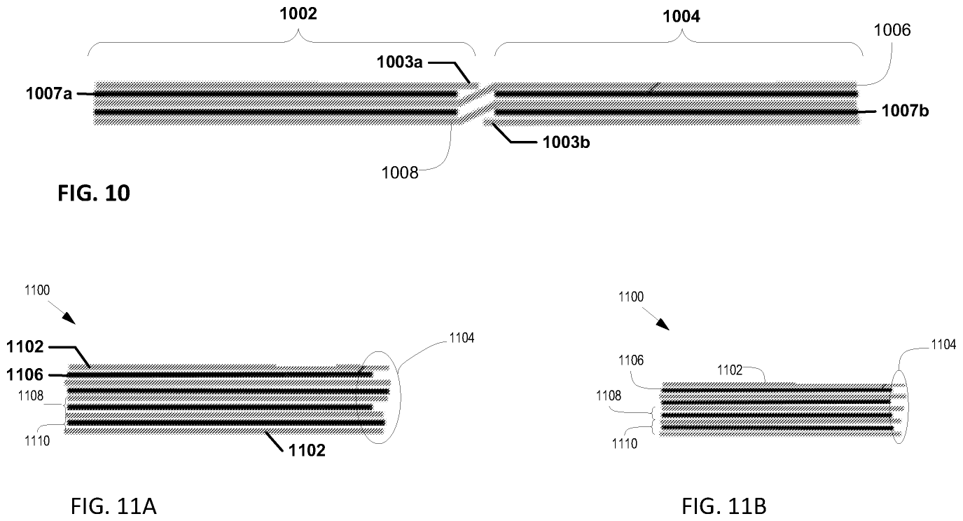

Referring to FIG. 10, to prevent electrical shorts and/or arcing between sections of conductive layers, one or more layers of insulating material may lap (and/or overlap) segments of the conductive layers (e.g., layers of insulating material 1003a, 1003b extend past ends of respective ones of conductive layers 1007a, 1007b). As also shown in FIG. 10, insulative layer segment 1002 and insulative layer segment 1004 share layers of insulating material. For example, insulating material layer 1006 forms the top layer of insulative layer segment 1004 and a middle layer of insulative layer segment 1002 (and thus, insulative material 1006 is shared between insulative layer segments 1002, 1004). Similarly, insulating material layer 1008 forms the bottom layer of insulative layer segment 1002 and a middle layer of insulative layer segment 1004. Sharing of the insulating material layers (e.g., layers 1006, 1008) may extend across two or more insulative layer segments.

Referring to FIGS. 11A, 11B, in which like elements are provided having like reference designations, shown are other embodiments of a section of an insulating layer 1100 that can prevent electrical shorts or arcing. One or more layers of insulating material 1102 can be disposed about conductive layers 1106 with at least some of the layers of insulating material 1102 lapping (and/or overlapping or extending beyond ends of the conductive layers)

Insulative layer 1100 has a plurality of layers of insulating material (e.g., layers of insulating material 1102) alternating with a plurality of conductive layers 1106. As denoted by reference numeral 1104, at least some ends of the layers of insulating material 1102 extend beyond (or overlap) the ends of the conductive layers (e.g., sheet metal plates) 1106. Overlapping the ends of insulating material 1104 may prevent arcing between layers of stacked conductive layers (e.g., the conductive layers 1106 between insulative layers 1102).

### Additional Variants of the Insulating Layers

Sheet metal plates of the insulating layer can be coated by insulating, low- or high-friction, grinding-resistant or else materials or of several, on top of each other, layers thereof.

The sheet metal plates can be covered by the same coatings on both faces or by different materials on each surface. In particular, the structure-facing, exposed to grinding surface can be platted or otherwise provided with the grinding-resistant material and the internal to the stack face-by the insulation. Similarly, there can be low-friction material on the structure-facing surface and insulation on the other.

Sheet metal plates with different coatings or combinations of coating can be assembled in a stack, with grinding-resistant or low-friction coatings at the faces and with insulation inside the stack.

The same insulating effect can be achieved by stacking plates alternately with insulation material, e.g., films, like Kapton, Mylar, Teflon or applied by painting or otherwise and solidified insulating substances, like epoxy or Apiezon-N or a combination thereof. In some applications adhesion between the insulating material and the plates may not be required by the technical conditions and the arrangement can be formed by stacking alternating layers of the plates and insulating films without adhesive substances between them.

To avoid short circuit impedance paths (or more simply “shorts”) occurring between the edges of the electrically conducting plates various variants of “partial lap” arrangements between the plates and insulating films.

To prevent local shorts, which may occur due to cutting of sharp edges of the plates through the insulating layers the edges of the plates can be rounded up otherwise modified by adding chamfers by a deburring tool.

Multiple plates with the same in-plane shape can be cut simultaneously using waterjet cutting technique.

Tap welding of the stack of insulated plates may be acceptable in certain applications. This will provide more mechanical sustainability of the insulating layers at the facing each other surfaces of the insulating plates.

The insulating plates may be formed from a ferromagnetic metal. In the presence of an external magnetic field plates will magnetize in the same direction and will stick to each other over the whole contact surface with a very strong, due to their proximity, attractive pressure. This will reduce or eliminate the potential for the plates to slide relative to each other, thus providing integrity of the insulation between the insulation plates. Field distortion due to the presence of the ferromagnetic material will be negligible due to small thickness of the plates, particularly in case of normal to the surface of the plates external magnetic field, like in the insulative layers between pancakes described above.

Other than steel high electrical resistance structural materials, Nitronic 40 or 50, Inconel, Hastelloy, etc. can be used as the base material of the insulating plates.

In embodiments, structural plates can be made of electrically insulating materials, would such materials with appropriate mechanical strength be identified.

Various embodiments of the concepts, systems, devices, structures, and techniques sought to be protected are described above with reference to the related drawings. Alternative embodiments can be devised without departing from the scope of the concepts, systems, devices, structures, and techniques described. It is noted that various connections and positional relationships (e.g., over, below, adjacent, etc.) may be used to describe elements in the description and drawing. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive inclusion. For example, an apparatus, a method, a composition, a mixture or an article, that comprises a list of elements is not necessarily limited to only those elements but can include other elements not expressly listed or inherent to such apparatus, method, composition, mixture, or article.

Additionally, the term “exemplary” is means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e. one, two, three, four, etc. The term “plurality” indicates any integer number greater than one. The term “connection” can include an indirect “connection” and a direct “connection”.

References in the specification to “embodiments,” “one embodiment,” “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it may affect such feature, structure, or characteristic in other embodiments whether or not explicitly described.

Relative or positional terms including, but not limited to, the terms “upper,” “lower,” “right,” “left,” “vertical,” “horizontal,” “top,” “bottom,” and derivatives of those terms relate to the described structures and methods as oriented in the drawing figures.

The terms “overlying,” “atop,” “on top,” “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

1. An insulative layer for use in systems utilizing high temperature superconducting (HTS)materials, the insulative layer comprising:
a first layer of an insulative material;
a second layer of an insulative material; and
a third layer of a conductive material, the third layer positioned between the first and second layers.

2. The insulative layer of claim 1 where the insulative layer is provided as at least one of:
(a) a pancake-to-pancake insulator configured to be disposed between pancakes in a TF magnet;
(b) a ground insulator configured to be disposed between pancakes and a structural case of a TF magnet;
(c) an insulator configured to be disposed between structural TF cases;
(d) insulation configured to be disposed between one or more structural TF cases and an outside diameter (OD) of a central solenoid (CS); and
(e) insulation configured to be disposed between electrically conducting parts.

3. The insulative layer of claim 1 wherein the third layer comprises a ferromagnetic metal.

4. The insulative layer of claim 1 wherein the insulative material in at least one of the first and second layers is resistant to damage from grinding forces.

5. The insulative layer of claim 1 disposed at an interface between a toroidal field (TF) coil and a central solenoid (CS).

6. The insulative layer of claim 1 wherein the third layer comprises a sheet metal.

7. The insulative layer of claim 6 wherein at least one of the first and second layers comprises a wear-resistant insulating material.

8. The insulative layer of claim 1 wherein one or more of the first, second and third layers comprise multiple layers.

9. The insulative layer of claim 1 wherein the third layer is provided having a resistance to oxidative degradation, weather, and radiation, as well as resistance to abrasive and fictional wear at cryogenic temperatures.

10. The insulative layer of claim 9 wherein at least one of the first and second layers comprise a 650- or 650-T series polyimide.

11. The insulative layer of claim 1 wherein the third layer comprises sheet metal having a thickness in the range of about 25 microns to about 0.25 mm.

12. The insulative layer of claim 1 wherein at least one of the first and second layers are provided having a thickness in the range of about 0.1 mm to about 2.0 mm.

13. The insulative layer of claim 1 disposed between pancakes in a toroidal field (TF) magnet.

14. The insulative layer of claim 1 disposed between pancakes and a structural case of a TF magnet.

15. The insulative layer of claim 1 disposed between structural TF cases.

16. A high temperature superconducting (HTS) magnet comprising:
a first magnet structure comprising an HTS coil and a housing, the housing formed from a conductive metal;
a second magnet structure comprising an HTS coil and a housing, the housing formed from the conductive metal;
an insulating structure disposed between the first magnet structure and the second magnet structure, the insulating structure comprising:
a sheet of conductive metal having a first surface and a second surface;
a first insulative material disposed on the first surface of the sheet of conductive metal; and
a second insulative material disposed on the second surface of the sheet of conductive metal;
wherein the insulating structure is positioned so that the first insulative material is adjacent to the first magnet structure and the second insulative material is adjacent to the second magnet structure.

17. The HTS magnet of claim 16 wherein the sheet of conductive metal comprises steel.

18. The HTS magnet of claim 16 wherein the first and second insulative material comprises polyimide.

19. The HTS magnet of claim 16 wherein the insulative structure comprises a plurality of layered structures, each one of the plurality of layered structures comprising:
a conductive layer, having first and second opposing surfaces;
one or more layers of insulative material disposed on a first one of the first and second surfaces of the conductive layer; and
one or more layers of insulative material disposed on a second one of the first and second surfaces of the conductive layer.

20. The HTS magnet of claim 19 wherein the conductive layer comprises one or more layers of a conductive material.

21. A high temperature superconducting (HTS) magnet comprising:
a first magnet structure comprising an HTS coil and a housing, the housing formed from a conductive metal;
a second magnet structure comprising an HTS coil and a housing, the housing formed from the conductive metal;
at least one bolt assembly comprising a bolt head, a nut, and a shaft extending through the first and second magnet structures; and
a first insulating layer disposed between at least a portion of the bolt head and the first magnetic structure;
a second insulating layer disposed between at least a portion of the nut and the second magnetic structure; and
a third insulating layer disposed around the shaft;
wherein the first, second, and third insulating structures comprise:
a sheet of conductive metal having first and second opposing surfaces;
a first insulative material disposed on a first one of the first and second surfaces of the sheet of conductive metal; and
a second insulative material disposed on a second one of the first and second surfaces of the sheet of conductive metal.

22. An interface layer to buffer adjacent magnet structures, the interface layer comprising:
a first layer including an electrically insulating material;
a second layer including an electrically insulating material; and
a third layer between the first layer and the second layer, the third layer comprising a metal.

23. The interface layer of claim 22, wherein the electrically insulating material of the first layer and the electrically insulating material of the second layer are both resistant to grinding forces.

24. The interface layer of claim 22 or claim 23, wherein the first layer and/or the second layer comprises polyimide.

25. The interface layer of any of claims 22-24, wherein the first layer has a thickness of between 25 and 50 microns.

26. The interface layer of any of claims 22-25, wherein the third layer includes a sheet metal.

27. The interface layer of claim 26, wherein the sheet metal has a thickness between 25 and 250 microns.
